(19) United States
(12) Patent Application Publication
(10) Pub. No.: US 2012/0279634 A1
(43) Pub. Date: Nov. 8, 2012

(54) METHODS AND KITS FOR THE CONSTRUCTION AND REPAIR OF COMPOSITE ARMOUR

(76) Inventor: MICHAEL COHEN, Gush Etzion (IL)

(21) Appl. No.: 13/344,846

(22) Filed: Jan. 6, 2012

(30) Foreign Application Priority Data
Jan. 9, 2011 (IL) 210526
Jan. 28, 2011 (RU) 2011/1103159

(51) Int. Cl. B29C 73/04; B29C 73/24; B29C 70/68

(52) U.S. Cl. 156/98; 264/219; 425/11; 425/175; 156/349

(57) ABSTRACT

This invention provides methods for producing a composite armor panel comprising a plurality of ceramic bodies, methods for repairing a composite armor panel comprising a plurality of ceramic bodies and kits for effecting the same. The methods and kits make use of a room-temperature curable binder material.

### BACKGROUND OF THE INVENTION

Ceramic bodies are used in armored plates and provide ballistic protection for personnel as well as for light and heavy mobile equipment and for vehicles against high-velocity, armor-piercing projectiles or fragments.

There are four main considerations concerning protective armor panels. The first consideration is weight. Protective armor for heavy but mobile military equipment, such as tanks and large ships, is known. Such armor usually comprises a thick layer of alloy steel, which is intended to provide protection against heavy and explosive projectiles. However, reduction of weight of armor, even in heavy equipment, is an advantage since it reduces the strain on all the components of the vehicle. Furthermore, such armor is quite unsuitable for light vehicles such as automobiles, jeeps, light boats, or aircraft, whose performance is compromised by steel panels having a thickness of more than a few millimeters, since each millimeter of steel adds a weight factor of 7.8 kg/m2.

Armor for light vehicles is expected to prevent penetration of bullets of any type, even when impacting at a speed in the range of 700 to 1000 meters per second. However, due to weight constraints it is difficult to protect light vehicles from high caliber armor-piercing projectiles, e.g. of 12.7 and 14.5 mm, since the weight of standard armor to withstand such projectile is such as to impede the mobility and performance of such vehicles.

A second consideration is cost. Overly complex armor arrangements, particularly those depending entirely on synthetic fibers, can be responsible for a notable proportion of the total vehicle cost, and can make its manufacture non-profitable.

A third consideration in armor design is compactness. A thick armor panel, including air spaces between its various layers, increases the target profile of the vehicle. In the case of civilian retrofitted armored automobiles which are outfitted with internal armor, there is simply no room for a thick panel in most of the areas requiring protection.

A fourth consideration relates to ceramic plates used for personal and light vehicle armor, which plates have been found to be vulnerable to damage from mechanical impacts caused by rocks, falls, etc.

In addition, of the known armor panels, most suffer the limitation that such panels do not have multi-hit capability.

Thus a light-weight, armor panel, without the above-limitations is as yet lacking

### SUMMARY OF THE INVENTION

In one embodiment, this invention provides a method for producing a composite armor panel, said method comprising:
(a) providing a horizontal frame which can be assembled to comprise at least four sides and bounding a fillable void;
(b) arranging a plurality of ceramic bodies containing a curvature at an apical surface of said bodies within said horizontal frame in said fillable void;
(c) applying a room-temperature curable binder material to said fillable void such that said room temperature curable binder material substantially coats at least a portion of an outer surface of said ceramic bodies;
(d) providing conditions whereby said room-temperature curable binder material cures and thereby forms an integral composite ceramic body-containing armor panel; and
(e) optionally removing said horizontal frame from said integral composite ceramic pellet containing panel.

According to this aspect, and in some embodiments, the method further comprises the steps of:
(f) positioning a high-performance textile within said fillable void;
(g) arranging said plurality of ceramic bodies containing a curvature at an apical surface of said bodies on top of said high-performance textile; and
(h) applying said room-temperature curable binder material to said fillable void over said high-performance textile.

According to this aspect and in some embodiments, the high-performance textile comprises Kevlar®, Dyneema® or Spectra®.

In some embodiments, the ceramic bodies are substantially cylindrical.

In some embodiments, the term “substantially” with particular reference to a geometric shape, as with reference to the segment of the ceramic body along the long axis of such body characterized as being substantially cylindrical in shape, or as with reference to the integrally formed substantially convexly curved impact receiving end face, that such term “substantially” means that from at 51%-100% of the referenced element will approximate a shape consistent with the designated geometric shape. Thus, a ceramic body segment along the long axis of such body, which is “substantially cylindrical”, will be characterized in that more than 51% of the overall shape of the ceramic body segment will assume a cylindrical shape. Similarly, a substantially convexly curved impact receiving end face will indicate that from at least 51% to about 95% of a contour line of an outer surface of such end face will be convexly curved. According to this aspect, the term “substantially” will provide for a geometric shape which is not 100% concordant with the indicated shape, since as noted herein, the distal segment of the end face is characterized by a configuration which is not convexly curved. Therefore, the term “substantially” refers to an element characterized in that between 51% and 100% assumes the indicated geometry unless such element is precluded from being characterized by assuming 100% of such shape, as described herein, in which case the term “substantially” will refer to an element characterized in that between 51% and 95% of the indicated element will assume the referenced geometry.

In some embodiments, the arranging of said ceramic bodies in step (b) is further characterized by providing substantially no space between adjacent ceramic bodies, such that at least a portion of the contact region between adjacent ceramic bodies is devoid of said room temperature curable binder. In some embodiments, the arranging of said ceramic bodies in step (b) is further characterized by providing a small space between adjacent ceramic bodies, such that the contact region between adjacent ceramic bodies comprises at least a thin layer of said room temperature curable binder.

In some embodiments, the ceramic bodies are arranged in a plurality of adjacent rows and columns, the major axis of said pellets being in substantially parallel orientation with each other.

According to this aspect and in some embodiments, the columns are substantially perpendicular to said rows and wherein for each of one of said rows, the ceramic bodies of said each row are spaced from one another and for each of one of said columns the ceramic bodies of said each column are spaced from one another such that each of a majority of said ceramic bodies contacts two ceramic bodies in a first adjacent row and two ceramic bodies in a second adjacent row, so that each of a majority of the ceramic bodies is in contact with four and four alone, adjacent ceramic bodies, and where for each row, the centers of adjacent ceramic bodies in said each row are spaced from one another substantially by a first distance for each column the centers of adjacent ceramic bodies in each said column are spaced from one another substantially by a second distance, wherein the first distance is different from the second distance.

In another aspect, and representing another embodiment of the invention, the ceramic bodies are arranged in a plurality of adjacent rows and columns, the major axis of said ceramic bodies being in substantially parallel orientation with each other and wherein a majority of each of said ceramic bodies is in direct contact with six adjacent ceramic bodies, with the flanks of three adjacent ceramic bodies forming a contact valley therebetween

In some embodiments, the method further comprises applying a primer material to an outer surface of said ceramic bodies.

In some embodiments, the horizontal frame comprises a bottom in addition to at least four sides, which bottom and said at least four sides bounds a fillable void. In some embodiments, the horizontal frame comprises a non-stick exposed surface which surface bounds said fillable void. In some embodiments, the horizontal frame comprises an exposed surface which promotes bonding of said binder material to said frame.

In some embodiments, the ceramic bodies are arranged in a single layer within said fillable void in said frame. In some embodiments, the ceramic bodies are arranged in two or more layers within said fillable void in said frame.

In some embodiments, the frame is comprised of metal, wood or plastic.

In some embodiments, the room-temperature curable binder material comprises a polyurethane, an epoxy, an unsaturated polyester, an acrylic or a silicone.

In some embodiments, the invention provides a method for repairing a composite armor panel, said method comprising:
(a) replacing at least one of a plurality of ceramic bodies containing a curvature at an apical surface of said pellets within a composite armor panel whose removal is desired;
(b) applying a room-temperature curable binder material to an area proximal to that in which said at least one of said a plurality of substantially ceramic bodies was replaced such that said room temperature curable binder material substantially coats said at least one of a plurality of ceramic bodies, optionally leaving a portion of an outer surface area of said curvature of said ceramic bodies uncoated; and
(d) providing conditions whereby said room-temperature curable binder material cures and thereby forms an integral composite ceramic body-containing armor panel.

According to this aspect, and in some embodiments, the method further comprises the step of placing a high-performance textile product underneath and proximal to the region wherein said at least one of a plurality of substantially ceramic bodies containing a curvature at an apical surface of said pellets within a composite armor panel whose removal is desired is located prior to said applying in step (b).

According to this aspect and in some embodiments, the method further comprises the step of applying a primer to said area proximal to that in which said at least one of said a plurality of substantially cylindrical ceramic pellets was replaced prior to applying said room-temperature curable binder material.

In some embodiments, the invention provides a kit for preparing or repairing a composite ceramic body-containing panel, said kit comprising:
at least one room-temperature curable binder material;
a plurality of substantially cylindrical ceramic bodies containing a curvature at an apical surface of said pellets; and
instructions for the repair of a composite ceramic pellet-containing panel.

According to this aspect, and in some embodiments, the kit may further comprise tools for the removal of defective ceramic pellets within a composite ceramic pellet-containing armor; tools for applying said room-temperature curable binder or a combination thereof.

According to this aspect, and in some embodiments, the kit may further comprise a horizontal frame which can be assembled to comprise at least four sides and bounding a fillable void

It is to be understood that the methods of this invention may employ use of the kits as herein described.

### BRIEF DESCRIPTION OF THE DRAWINGS

Various embodiments of a ceramic body are described herein with reference to the figures wherein:

FIG. 1A schematically depicts an embodiment of a method of this invention, whereby a rectangular frame is depicted 1-10, within which a plurality of ceramic bodies 1-20 are arranged being filled with a room temperature curable binder material. FIG. 1B depicts the same method of FIG. 1A, however, as the application of the room-temperature curable binder material is applied, in this aspect, the apical regions 1-70 of the ceramic bodies are not covered by the binder material. FIG. 1C depicts that a cover 1-80 may be placed on top of the apical regions of the ceramic bodies thereby covering the panel and obscuring the nature of the armor.

FIG. 2A depicts another embodiment of a frame 2-10, within which a plurality of ceramic bodies 2-20 is arranged. In this embodiment, the frame is shaped to approximate the structure of a vehicular door or panel. FIG. 2B depicts the same method of FIG. 2A, however, as the application of the room-temperature curable binder material is applied, in this aspect, the apical regions 2-70 of the ceramic bodies are not covered by the binder material. A cover 2-80 may be placed on top of the apical regions of the ceramic bodies thereby covering the panel and obscuring the nature of the armor.

FIG. 3A-3D schematically depicts an embodied application of a repair method of the invention. FIGS. 3A and 3B show lower and higher magnification of the use of any means or tool 3-10 for the exposure of defective ceramic bodies 3-20. Such defective ceramic bodies may be removed and replaced with intact ceramic bodies 3-30, for example as depicted in FIG. 3C. FIG. 3D shows that a room-temperature curable binder material is applied proximal to the area of repair.

FIG. 4 schematically depicts additional embodiments of the panels obtained by the methods of this invention. According to this aspect, in FIG. 4A, a rectangular frame is depicted 4-10, within which a plurality of ceramic bodies 4-20 are arranged on a ballistic textile 4-30, and the frame is then filled with a room temperature curable binder material 4-40. As the application of the room-temperature curable binder material is applied, in this aspect, the apical regions 4-70 of the ceramic bodies are not covered by the binder material. FIG. 4B depicts the same method of FIG. 4A, however, a cover 4-80, which may be placed on top of the apical regions of the ceramic bodies thereby covering the panel and obscuring the nature of the armor is shown. FIG. 4C depicts another embodiment of the method, whereby a ballistic textile 4-30 may be placed within the frame onto which the ceramic bodies 4-20 are arranged, and once filled with the room curable binder material 4-40, then a further layer of ballistic textile may be positioned apically 4-80 serving as a cover therefore.

### DETAILED DESCRIPTION OF THE INVENTION

This invention provides, in some embodiments, methods for producing composite panels.

The method entails arranging a plurality of ceramic bodies containing a curvature at an apical surface of the bodies within a fillable void in a horizontal frame.

Composite armored panels/plates which comprise ceramic bodies containing a curvature in at least one exposed end thereof are well known in the art (see, for example U.S. Pat. No. 6,203,908 to Michael Cohen, U.S. Pat. No. 6,408,734 to Michael Cohen, U.S. Pat. No. 5,763,813 to Michael Cohen, U.S. Pat. No. 6,289,781, U.S. Pat. No. 5,361,678, U.S. Pat. No. 3,705,558, U.S. Pat. No. 3,523,057, U.S. Pat. No. 5,134,725; the entire contents of each of which is hereby incorporated by reference).

In some embodiments, the ceramic bodies as described herein are comprised of any suitable material, for example, sintered refractory materials or ceramic materials, for example, aluminum oxide, or in some embodiments, ceramic materials having a specific gravity below that of aluminium oxide, e.g., boron carbide with a specific gravity of 2.45, silicon carbide with a specific gravity of 3.2 silicon aluminum oxynitride with a specific gravity of about 3.2, and others, as will be appreciated by the skilled artisan. In some embodiments, the ceramic bodies as described herein are comprised of a material, for example, as described in EP-A-0843149 to Michael Cohen, European patent application 98301769.0 to Michael Cohen, WO-A-9815796 to Michael Cohen, WO 99/60327 to Michael Cohen, the teachings of each of which is fully incorporated by reference herein.

In some embodiments, the ceramic bodies will be comprised of a material such as sintered oxides, nitrides, carbides and borides of magnesium, zirconium, tungsten, molybdenum, titanium, silica and others

In some embodiments, the ceramic bodies will be comprised of a material such as alumina, boron carbide, glass, boron nitride, titanium diboride, silicon carbide, silicon nitride, silicon oxide, silicon nitride, magnesium oxide, silicon aluminum oxynitride and mixtures thereof. In some embodiments, the ceramic bodies will be comprised of asintered, yttria stabilized zirconium-toughened alumina ceramic product, such as that described in US20090163346A1 to Michael Cohen, fully incorporated herein by reference.

In some embodiments, the ceramic bodies will be comprised of a material such as glass, sintered refractory material and ceramic material, and having at least one axis of at least 3 mm length and in some embodiments, such ceramic bodies may each have a substantially regular geometric form, and in some embodiments, such ceramic bodies are further characterized in that a channel is provided in each of a said pellets.

In some embodiments, the ceramic bodies will have at least one axis having a length in the range of from about 12 to 40 mm. In some embodiments, when an armored plate comprising such bodies is assembled, such plate will have a weight which does not exceed 185 kg/m².

In some embodiments, the ceramic body has a ratio D/R between the diameter D of said ceramic body and the radius R of curvature of said convexly curved end face which ratio is at least 0.64:1. In some embodiments, the ceramic body has a ratio D/R between the diameter D of said ceramic body and the radius R of curvature of said convexly curved end face which ratio is at least 0.85:1. In some embodiments, the ceramic body has a ratio D/R between the diameter D of said ceramic body and the radius R of curvature of said convexly curved end face which ratio is between at least 0.85:1-1/28:1.

According to this aspect, and in some embodiments, the ratio D/R of the ceramic body with regard to the diameter D of the ceramic body and the radius R of curvature of the convexly curved end face, that such R value is with regard to a proximal segment of the convexly curved end face, and the values described hereinabove are specifically with reference to such proximal segment.

In some embodiments, the relative ratios H/D/R of the height H of said cylindrical body, excluding the height of said convexly curved end face, the diameter of said cylindrical body D, and the radius R of curvature of said at least one convexly curved end face is between about 7.5:12.8:9 and 7.5:12.8:20.

In accordance with the methods of this invention, the ceramic bodies of choice are arranged within a fillable void in a horizontal frame.

In some embodiments, the term “horizontal frame” is to be distinguished from that of a “vertical frame”, when assembled and containing the arranged ceramic bodies and binder material therein form a structure defined as having a greater value for the width of the structure than that of its depth or height.

In some embodiments, the term “horizontal frame” will be understood to be capable of assembly to form a structure having at least four sides, and when positioned on a surface, forming a boundary about a fillable void. The methods of this invention may make use, in some embodiments, of single planks or bars, which can be assembled into a “frame” structure, which in turn forms a boundary about a fillable void. The methods of this invention may make use, in some embodiments, of elbow shaped planks, which can then be assembled into such “frame” structure. In some embodiments, any number of elements may be utilized, which when assembled to form a frame structure result in the formation of a boundary about a fillable void, are appropriate for incorporation and use in accordance with the methods of this invention. In some embodiments, such frame may assume any geometric shape, when bounding a void, for example, a square, rectangular, diamond, pentagon or any desired shape. In some embodiments, the frame shape will approximate a desired configuration for the panel whose assembly is desired.

In some embodiments, the frame is comprised of metal, wood, plastic or any other suitable material.

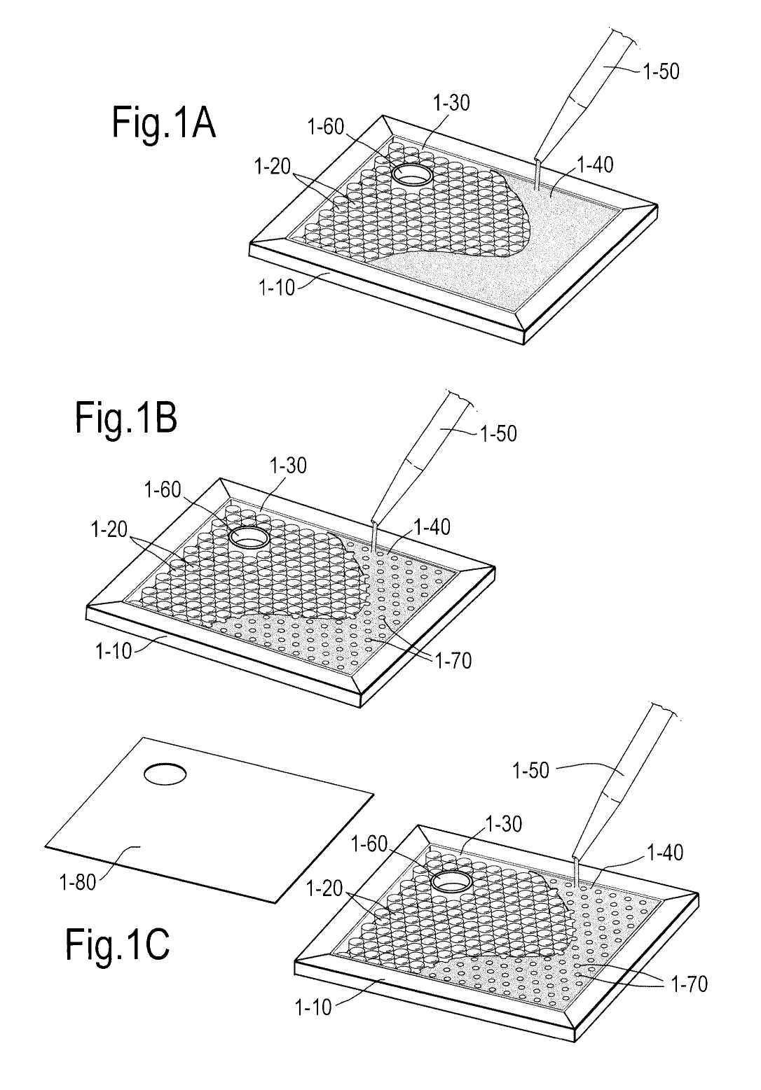

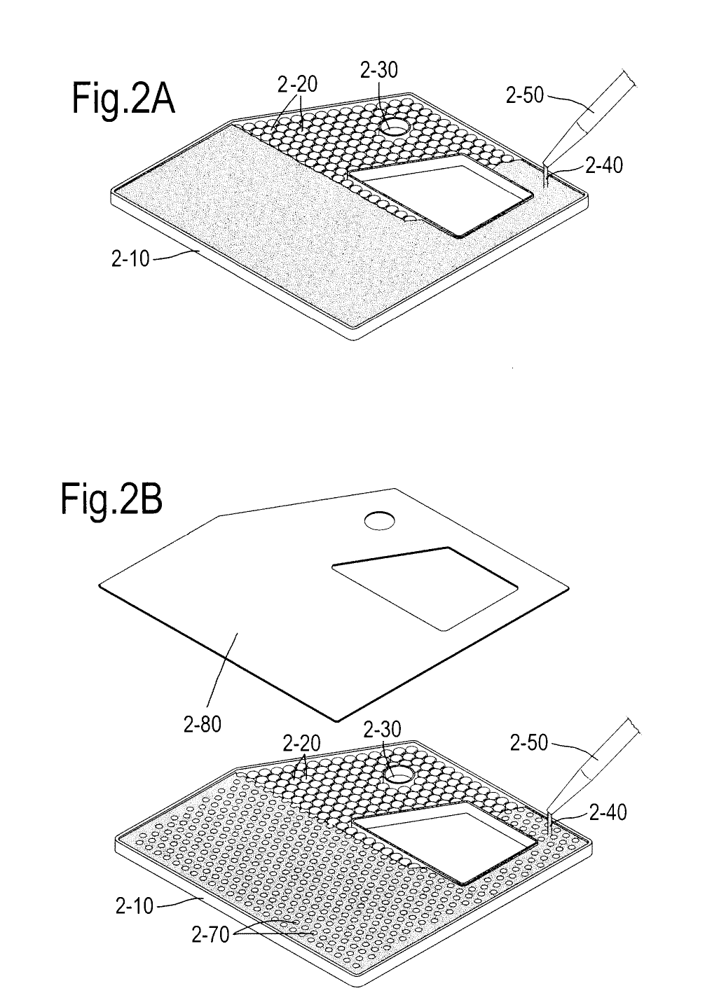

Referring now to FIG. 1, a frame is depicted 1-10, within which a plurality of ceramic bodies 1-20 is arranged. In this embodiment, the frame is rectangularly-shaped and the walls of the frame have a pronounced thickness. FIG. 2 depicts another embodiment of a frame 2-10, within which a plurality of ceramic bodies 2-20 is arranged. In this embodiment, the frame is shaped to approximate the structure of a vehicular door or panel. According to this aspect, the walls of the frame do not have a pronounced thickness. FIG. 2B depicts the same method of FIG. 2A, however, as the application of the room-temperature curable binder material is applied, in this aspect, the apical regions 2-70 of the ceramic bodies are not covered by the binder material. A cover 2-80 may be placed on top of the apical regions of the ceramic bodies thereby covering the panel and obscuring the nature of the armor.

In some embodiments, in addition to an outer frame, the methods may make use of an insert 1-30 within the frame, within which insert, the ceramic bodies are arranged (FIG. 1).

FIG. 1B depicts an aspect of the method of this invention, wherein as the application of the room-temperature curable binder material is applied, in this aspect, the apical regions 1-70 of the ceramic bodies are not covered by the binder material. A cover 1-80 may be placed on top of the apical regions of the ceramic bodies thereby covering the panel and obscuring the nature of the armor (FIG. 1C).

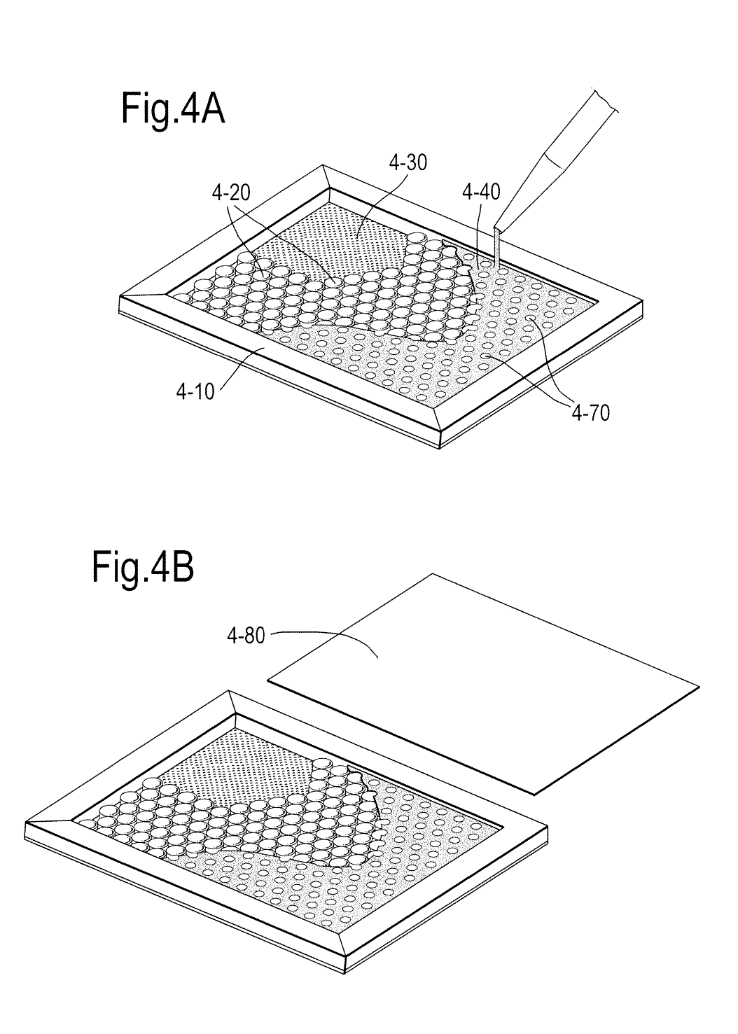

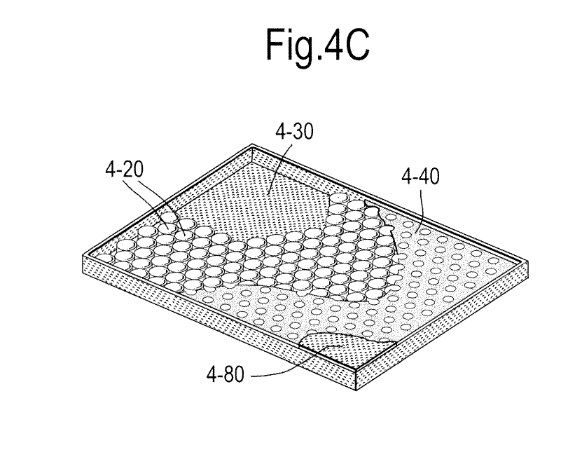

FIG. 4 schematically depicts additional embodiments of the panels obtained by the methods of this invention. According to this aspect, in FIG. 4A, a rectangular frame is depicted 4-10, within which a plurality of ceramic bodies 4-20 are arranged on a ballistic textile 4-30, and the frame is then filled with a room temperature curable binder material 4-40. As the application of the room-temperature curable binder material is applied, in this aspect, the apical regions 4-70 of the ceramic bodies are not covered by the binder material. FIG. 4B depicts the same method of FIG. 4A, however, a cover 4-80, which may be placed on top of the apical regions of the ceramic bodies thereby covering the panel and obscuring the nature of the armor is shown. FIG. 4C depicts another embodiment of the method, whereby a ballistic textile 4-30 may be placed within the frame onto which the ceramic bodies 4-20 are arranged, and once filled with the room curable binder material 4-40, then a further layer of ballistic textile may be positioned apically 4-80 serving as a cover therefore.

In some embodiments, the horizontal frame comprises a non-stick exposed surface which surface bounds said fillable void. In some embodiments, within the frame may be placed an insert, which in turn comprises such a non-stick exposed surface. Some examples of non-stick surfaces are inert plastics, Teflon, and others, as will be appreciated by the skilled artisan.

In some embodiments, the horizontal frame comprises an exposed surface which promotes bonding of the applied binder material to the frame. In some embodiments, within the frame may be placed an insert, which in turn comprises an exposed surface which promotes bonding of the applied binder material to the insert.

In some embodiments, the term “exposed surface which promotes bonding of the applied binder material” to the designated structure may refer to construction of the indicated structure from a material which is so characterized, or in some embodiments, such structures may be coated or treated to promote the said bonding. In some embodiments, a primer may be applied to the indicated structure to promote such bonding. Any suitable primer known in the art may be thus utilized, for example, and as the skilled artisan will appreciate, the primer will be appropriate for the particular resin being utilized. In another embodiment, the structure may be treated, for example, by sputter coating or other known means.

In some embodiments, the method may further comprise the steps of:
e. positioning a high-performance textile within said fillable void;
f. arranging said plurality of substantially cylindrical ceramic pellets containing a curvature at an apical surface of said pellets on top of said high-performance textile; and
g. applying said room-temperature curable binder material to said fillable void over said high-performance textile.

In some embodiments, such high-performance textile will comprise any appropriate one known to the skilled artisan, for example, Kevlar®, Dyneema® or Spectra®.

In some embodiments, such high-performance textile will strengthen the panel, and in some embodiments, such strengthening is particularly suitable when facing extreme environmental conditions such as extreme heat or extreme cold.

In accordance with the methods of this invention, the ceramic bodies are arranged within the frame. As will be appreciated by the skilled artisan, such arrangement will be within the frame, within the insert applied within the frame, within a region designated for placement of the ceramic bodies. Such region is referred to herein as a “fillable void”, wherein within such void, ceramic bodies are arranged and a room-temperature curable binder material is then applied, to achieve the composite panels as herein described.

The arrangement of the ceramic bodies within the frame may be according to any design or pattern and may utilize ceramic bodies varying in terms of their length, diameter, composition, or a combination thereof, which will suit a desired purpose, as will be appreciated by the skilled artisan.

For example, and in some embodiments, the panels may be thus adjusted to suit coming into contact with projectiles of between 5.56 and 9 mm, as will be appreciated by the skilled artisan. It will be appreciated that panels may be designed to be suitable for exposure to larger projectiles, as well.

In some embodiments, the ceramic bodies are arranged in a plurality of adjacent rows and columns, the major axis of said pellets being in substantially parallel orientation with each other.

According to this aspect and in some embodiments, the columns are substantially perpendicular to said rows and wherein for each of one of said rows, the ceramic bodies of said each row are spaced from one another and for each of one of said columns the ceramic bodies of said each column are spaced from one another such that each of a majority of said ceramic bodies contacts two ceramic bodies in a first adjacent row and two ceramic bodies in a second adjacent row, so that each of a majority of the ceramic bodies is in contact with four and four alone, adjacent ceramic bodies, and where for each row, the centers of adjacent ceramic bodies in said each row are spaced from one another substantially by a first distance for each column the centers of adjacent ceramic bodies in each said column are spaced from one another substantially by a second distance, wherein the first distance is different from the second distance.

In another aspect, and representing another embodiment of the invention, the ceramic bodies are arranged in a plurality of adjacent rows and columns, the major axis of said ceramic bodies being in substantially parallel orientation with each other and wherein a majority of each of said ceramic bodies is in direct contact with six adjacent ceramic bodies, with the flanks of three adjacent ceramic bodies forming a contact valley therebetween

In some embodiments, the ceramic bodies are arranged in a single layer within said fillable void in said frame. In some embodiments, the ceramic bodies are arranged in two or more layers within said fillable void in said frame.

In some embodiments, the composite armor of this invention will be so arranged such that a compact array of a ceramic body in direct contact with 4 adjacent ceramic bodies is achieved.

In some embodiments, the composite armor of this invention will be so arranged such that each of a majority of the pellets along an edge of the plate is in direct contact with four adjacent pellets, while internal pellets in a plurality of rows within the plate are in direct contact with six adjacent pellets.

In some embodiments, the composite armor of this invention will be so arranged such that a compact array of a ceramic body in direct contact with 6 adjacent ceramic bodies is envisioned, whereby such armor has a greater weight per square foot or meter than does an array wherein each pellet is in contact with only 4 adjacent pellets.

In some embodiments, the composite armor of this invention will be so arranged such that the ceramic bodies are arranged in a plurality of adjacent rows and columns, the major axis of said bodies being in substantially parallel orientation with each other and wherein a majority of each of said bodies is in direct contact with six adjacent bodies, with the flanks of three adjacent bodies forming a contact valley therebetween.

In some embodiments of the present invention, panels assembled by the methods of this invention may comprise an inner and an outer surface, with the outer surface facing the impact side and embodied ceramic bodies being arranged in a plurality of adjacent rows, the cylinder axis of said bodies being substantially parallel with each other and perpendicular to the surfaces of the panel with curved impact receiving end faces of each of such ceramic bodies directed to the outer surface and said composite armor further comprises an inner layer adjacent said inner surface of said panel, said inner layer being formed from a plurality of adjacent layers, each layer comprising a plurality of unidirectional coplanar anti-ballistic fibers embedded in the room-temperature curable binder material, where, in some embodiments, the fibers of adjacent layers are at an angle of between about 45° to 90° to each other.

According to a further aspect of the invention, panels assembled by the methods of this invention may be in the form of multi-layered composite armor panel, comprising an outer, impact-receiving layer formed by a shock absorbing panel as hereinbefore defined; and an inner layer adjacent to said outer layer and, comprising a ballistic material for absorbing any remaining kinetic energy from the impacting projectile and consequences thereto. It will be appreciated that the ballistic material may be any that is appropriate for the desired task, as will be known to the skilled artisan, for example, the choice of material may reflect considerations of cost and weight, as well as the desired properties for the expected impacting projectile. In some embodiments, the material may comprise, but is not limited to Dyneema, Kevlar, aluminum, steel, titanium, or S2, or combinations thereof.

In other embodiments of the present invention, panels assembled by the methods of this invention may comprise an outer, impact receiving panel of a multi-layered armor panel further comprising an inner layer adjacent to said outer plate, comprising a second ballistic panel, wherein said outer plate, inter alia serves to deform and shatter an impacting high velocity armor-piercing projectile and said second ballistic panel is adapted to retain any remaining fragments from said projectile and from said bodies and to absorb remaining energy from said fragments. According to this aspect, and in some embodiments, the second ballistic panel can be made of any suitable ballistic material including but not limited to aluminium, titanium, Kevlar®, Dyneema®, S2, and combinations thereof.

In some embodiments, panels assembled by the methods of this invention may comprise a single internal layer of the embodied ceramic bodies, which are bound and retained in plate form by the room-temperature curable binder material substantially internally therewithin, such that the ceramic bodies are bound in a plurality of spaced-apart rows and columns, and such ceramic bodies are substantially fully embedded in the binder material so that the ceramic bodies form an internal layer, characterized in that a majority of each of such ceramic bodies are in direct contact with four diagonally-adjacent ceramic bodies in the same layer to provide mutual lateral confinement there-between and are retained in a spaced-apart relationship relative to ceramic bodies in the same row and ceramic bodies in the same column by the elastic material.

According to another embodied aspect of the invention panels assembled by the methods of this invention may comprise a plurality of ceramic bodies and a room-temperature curable binder material in which the ceramic bodies are embedded, the ceramic bodies being arranged in a layer consisting of a plurality of parallel rows of ceramic bodies and a plurality of parallel columns of ceramic bodies, with the columns being substantially perpendicular to the rows, wherein for each one of said rows the ceramic bodies of said each row are spaced from one another and for each one of said columns the ceramic bodies of said each column are spaced from one another, wherein each of a majority of the ceramic bodies contacts two ceramic bodies in a first adjacent row and two ceramic bodies in a second adjacent row so that each of a majority of the ceramic bodies is in contact with four, and four alone, adjacent ceramic bodies, and wherein for each row, the centers of adjacent ceramic bodies in said each row are spaced from one another by a first distance and for each column the centers of adjacent ceramic bodies in said each column are spaced from one another by a second distance, wherein the first distance is different from the second distance.

Referring again to FIGS. 1 and 2, as can be seen, the ceramic bodies 1-20 are in these embodiments assembled in a plurality of rows and columns, in a single layer within the frame/insert. Not every available space within the void is necessarily packed with the ceramic bodies, and in some aspects, other structural requirements are incorporated within the frame/insert, for example, elements 1-30 to facilitate attachment of the assembled composite armor to an appropriate vehicle or for an appropriate application.

A room-temperature curable binder material is then applied to the fillable void such that the room temperature curable binder material substantially coats at least a portion of an outer surface of said ceramic bodies.

Referring to FIGS. 1 and 2, the room-temperature curable binder material 1-40 is applied via any appropriate means, including pouring directly, or filling via an applicator 1-50, etc.

The room-temperature curable binder material is applied, such that the room temperature curable binder material substantially coats said ceramic pellets, yet leaves a portion of an outer surface area of said curvature of said ceramic pellets uncoated.

In some embodiments, the room-temperature curable binder is a polyurethane, an epoxy, an unsaturated polyester, an acrylic, a silicone or a combination thereof. In some embodiments, such room-temperature curable binders are liquids or gels when first applied, and in response to the presence of appropriate conditions, solidify and comprise the composite armor as described herein.

In some embodiments, such appropriate conditions for curing of the binder material is the provision of appropriate time for solidification. In some embodiments, such appropriate conditions may also include addition of a catalyst, application of light of a particular wavelength, application of pressure, and other means, as known in the art to stimulate the curing of the binder material at room temperature.

In some embodiments, the methods of this invention may further comprise the optional step of removing the horizontal frame from said integral composite ceramic pellet containing panel.

In some embodiments, the invention provides a method for repairing a composite armor panel, said method comprising:
(a) replacing at least one of a plurality of substantially cylindrical ceramic pellets containing a curvature at an apical surface of said pellets within a composite armor panel whose removal is desired;
(b) applying a room-temperature curable binder material to an area proximal to that in which said at least one of said a plurality of substantially cylindrical ceramic pellets was replaced such that said room temperature curable binder material substantially coats said at least one of a plurality of substantially cylindrical ceramic pellets, optionally leaving a portion of an outer surface area of said curvature of said ceramic pellets uncoated; and
(d) providing conditions whereby said room-temperature curable binder material cures and thereby forms an integral composite ceramic pellet-containing armor panel;.

Currently, replacing individual ceramic bodies in composite armored plates is impractical and somewhat impossible, since existing methodology teaches assembly of such plates via means which do not allow for easy repair of singly damaged cylinders.

Described herein, however, is a method for preparing a composite armor panel, which makes use of a room-temperature curable binder for incorporation of the ceramic bodies within the composite armor panel, and therefore, if single or a proportion of the ceramic bodies on a given composite panel are damaged, then new cylinders can be readily applied, even in real-time exposure settings, via the methods described herein.

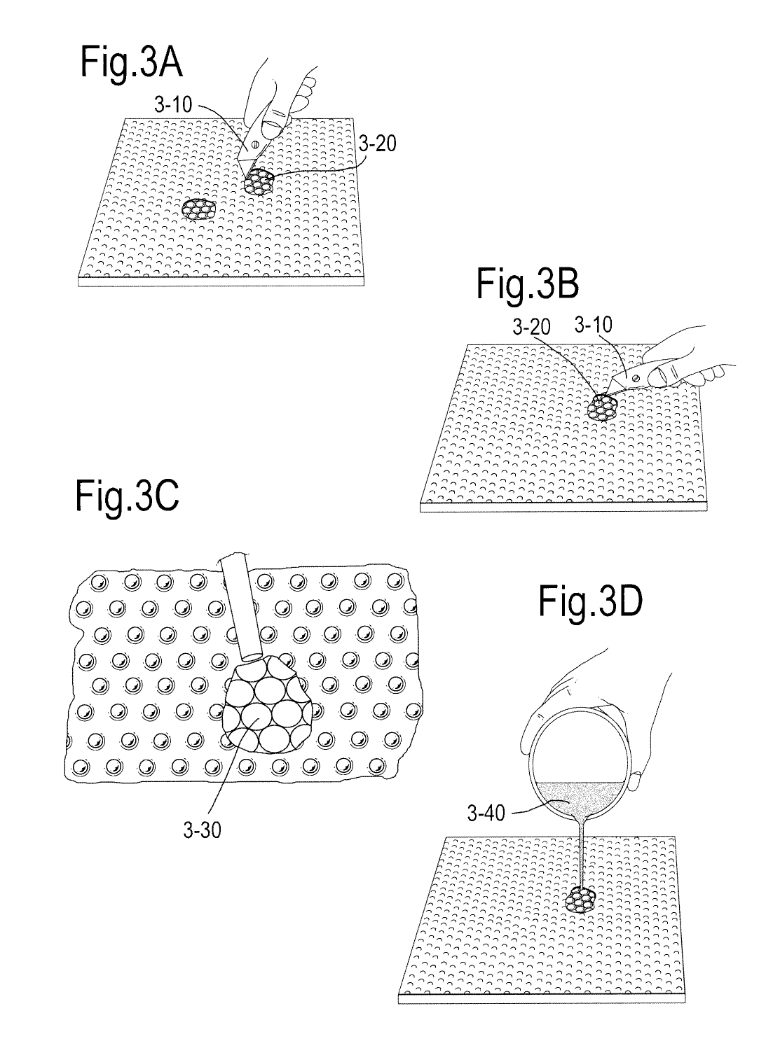

Referring to FIGS. 3A and 3B, the figure depicts an embodied application of the method as herein described. Any means or tool 3-10 may be utilized to expose and remove defective ceramic bodies 3-20 and replace the same with intact ceramic bodies 3-30. A room-temperature curable binder material is applied proximal to the area of repair. In some embodiments, the method may also comprise applying a proportion of the room-temperature curable binder to the area of repair prior to positioning the intact ceramic body within such region, and then upon subsequent positioning of the intact ceramic body within such region, the remainder of the room-temperature curable binder is applied.

In some embodiments, the method further comprises the step of placing a high-performance textile product underneath and proximal to the repair region, prior to applying the room-temperature curable binder. Such high performance textile product may serve as a patch, and may further strengthen or otherwise improve the integrity of the repaired composite armor panel at the region of repair.

In some embodiments, such high-performance textile comprises Kevlar®, Dyneema® or Spectra® or any other appropriate like material, as known in the art.

In some embodiments, the room-temperature curable binder material may comprise any embodiment as herein described for the same.

In some embodiments, the repair method may further comprise the step of applying a primer to the repair region prior to applying the room-temperature curable binder material.

In some embodiments, this invention provides a kit for preparing or repairing a composite ceramic pellet containing panel, said kit comprising:
at least one room-temperature curable binder material;
a plurality of ceramic bodies containing a curvature at an apical surface of said pellets; and
instructions for the repair of a composite ceramic pellet-containing panel.

According to this aspect, and in some embodiments, the room-temperature curable binder material and plurality of ceramic bodies elements of the kit may comprise any embodiment for such materials as herein described.

In some embodiments, the kit may further optionally comprise tools for the removal of defective ceramic pellets within a composite ceramic pellet-containing armor; tools for applying the room-temperature curable binder; a horizontal frame which can be assembled to comprise at least four sides and bounding a fillable void or a combination thereof.

In some embodiments, the kits as herein described may be made of use in the performance of the methods of this invention.

In some embodiments, the ceramic body will comprise an integrally formed substantially convexly curved impact receiving end face of such first end.

In some embodiments, such channels can be bored into preformed pellets or the pellets themselves can be pressed with such channel already incorporated therein.

This invention also provides for a composite armor prepared by a method and/or via use of the kits of this invention. In some embodiments, the ceramic bodies and composite armor constructed in accordance with the methods of this invention can be adapted to suit known composite armor and armor applications, for example, as described in U.S. Pat. Nos. 4,665,794, 4,179,979; 3,705,558; 4,945,814 5,763,813 or U.S. application Ser. Nos. 09/048,628 and 08/944,343 and represent contemplated embodiments of this invention. The skilled artisan will appreciate that additional related applications are also envisioned.

The invention provides advantages in the preparation and repair of composite armor panels over known and previously described methods and thereby produced composite armor, as will be appreciated by the skilled artisan. It is known that when manufacturing/preparing armored panels comprising ballistic ceramic bodies, a number of requirements should be ideally met, including high integrity of the armor panels in the face of incoming projectiles and as low weight as possible, for ease of transport and greater field application. Moreover, the ability to fix a compromised panel in a field setting in real time, is a clear advantage over existing methodology. It will be apparent to the skilled artisan that the above-described improvement represents only one potential improvement over known methods for the preparation of a composite armor panel, and others will be appreciated by the skilled artisan, and the methods and kits described herein are not restricted to showing such improvement or showing such improvement exclusively.

It is to be understood that repeated use of reference characters in the present specification and drawings is intended to represent the same or analogous features of the invention.

It will be understood by those skilled in the art that various changes in form and details may be made therein without departing from the spirit and scope of the invention as set forth in the appended claims. Those skilled in the art will recognize, or be able to ascertain using no more than routine experimentation, many equivalents to the specific embodiments of the invention described herein. Such equivalents are intended to be encompassed in the scope of the claims.

In the claims articles such as “a,”, “an” and “the” mean one or more than one unless indicated to the contrary or otherwise evident from the context. Claims or descriptions that include “or” or “and/or” between members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides, in various embodiments, all variations, combinations, and permutations in which one or more limitations, elements, clauses, descriptive terms, etc., from one or more of the listed claims is introduced into another claim dependent on the same base claim unless otherwise indicated or unless it would be evident to one of ordinary skill in the art that a contradiction or inconsistency would arise. Where elements are presented as lists, e.g. in Markush group format or the like, it is to be understood that each subgroup of the elements is also disclosed, and any element(s) can be removed from the group. It should it be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in haec verba herein.

The invention includes reference to assemblies comprising a recited list of elements, however it is to be understood with respect to the recited and claimed assemblies, that while additional elements may be incorporated within the assemblies of the invention, the term “comprising” is to be construed as “consisting” of these elements alone. In some embodiments of the invention, reference to the term “comprising” with respect to the recited list of elements of the claimed assemblies of this invention, is to include an assembly “consisting essentially of” such elements, where the term “consisting essentially of” such element refers to the fact that the minimal elements required for the proper functioning of the assembly are the recited elements thereto, however additional elements, which contribute to superior functioning of the claimed assembly, which impart properties unrelated to the protection afforded by the assembly from blast-associated energy, but nonetheless impart desired characteristics to the assembly are included within such definition.

Certain claims are presented in dependent form for the sake of convenience, but Applicant reserves the right to rewrite any dependent claim in independent format to include the elements or limitations of the independent claim and any other claim(s) on which such claim depends, and such rewritten claim is to be considered equivalent in all respects to the dependent claim in whatever form it is in (either amended or unamended) prior to being rewritten in independent format.

What is claimed is:

1. A method for producing a composite armor panel, said method comprising:
(a) providing a horizontal frame which can be assembled to comprise at least four sides and bounding a fillable void;
(b) arranging a plurality of ceramic bodies containing a curvature at an apical surface of said bodies within said horizontal frame in said fillable void;
(c) applying a room-temperature curable binder material to said fillable void such that said room temperature curable binder material substantially coats at least a portion of an outer surface of said ceramic bodies;
(d) providing conditions whereby said room-temperature curable binder material cures and thereby forms an integral composite ceramic body-containing armor panel; and
(e) optionally removing said horizontal frame from said integral composite ceramic pellet containing panel.

2. The method according to claim 1, further comprising the steps of:
a. positioning a high-performance textile within said fillable void;
b. arranging said plurality of ceramic bodies containing a curvature at an apical surface of said bodies on top of said high-performance textile; and
c. applying said room-temperature curable binder material to said fillable void over said high-performance textile.

3. The method according to claim 2, wherein said high-performance textile comprises Kevlar®, Dyneema® or Spectra®.

4. The method according to claim 1, wherein said ceramic bodies are substantially cylindrical.

5. The method according to claim 1, wherein arranging of said ceramic bodies in step (b) is further characterized by providing substantially no space between adjacent ceramic bodies, such that at least a portion of the contact region between adjacent ceramic bodies is devoid of said room temperature curable binder.

6. The method according to claim 1, wherein arranging of said ceramic bodies in step (b) is further characterized by providing a small space between adjacent ceramic bodies, such that the contact region between adjacent ceramic bodies comprises at least a thin layer of said room temperature curable binder.

7. The method according to claim 1, wherein said ceramic bodies are arranged in a plurality of adjacent rows and columns, the major axis of said pellets being in substantially parallel orientation with each other.

8. The method according to claim 7, wherein said columns are substantially perpendicular to said rows and wherein for each of one of said rows, the ceramic bodies of said each row are spaced from one another and for each of one of said columns the ceramic bodies of said each column are spaced from one another such that each of a majority of said ceramic bodies contacts two ceramic bodies in a first adjacent row and two ceramic bodies in a second adjacent row, so that each of a majority of the ceramic bodies is in contact with four and four alone, adjacent ceramic bodies, and where for each row, the centers of adjacent ceramic bodies in said each row are spaced from one another substantially by a first distance for each column the centers of adjacent ceramic bodies in each said column are spaced from one another substantially by a second distance, wherein the first distance is different from the second distance.

9. The method of claim 7, wherein said ceramic bodies are arranged in a plurality of adjacent rows and columns, the major axis of said ceramic bodies being in substantially parallel orientation with each other and wherein a majority of each of said ceramic bodies is in direct contact with six adjacent ceramic bodies, with the flanks of three adjacent ceramic bodies forming a contact valley therebetween.

10. The method according to claim 1, further comprising applying a primer material to an outer surface of said ceramic bodies.

11. The method according to claim 1, wherein said horizontal frame comprises a bottom in addition to at least four sides, which bottom and said at least four sides bounds a fillable void.

12. The method according to claim 1, wherein said horizontal frame comprises a non-stick exposed surface which surface bounds said fillable void.

13. The method of claim 1, wherein said horizontal frame comprises an exposed surface which promotes bonding of said binder material to said frame.

14. The method of claim 1, wherein said ceramic bodies are arranged in a single layer within said fillable void in said frame.

15. The method of claim 1, wherein said ceramic bodies are arranged in two or more layers within said fillable void in said frame.

16. The method of claim 1, wherein said frame is comprised of metal, wood or plastic.

17. The method of claim 1, wherein said room-temperature curable binder material comprises a polyurethane, an epoxy, an unsaturated polyester, an acrylic or a silicone.

18. The method of claim 1, wherein said ceramic bodies have an Al₂ O₃ content of at least 85% by weight and a specific gravity of at least at 2.5 g/cm3.

19. The kit of claim 1, wherein said ceramic bodies have an Al₂ O₃ content of at least 90% by weight and a specific gravity of at least 3 g/m.

20. The kit of claim 1, wherein said ceramic bodies are comprised of boron carbide, titanium dibromide, silicon carbide, magnesium oxide, silicon aluminum oxynitride, aluminum oxide or mixtures thereof.

21. A kit for preparing or repairing a composite ceramic pellet containing panel, said kit comprising:
at least one room-temperature curable binder material;
a plurality of substantially cylindrical ceramic pellets containing a curvature at an apical surface of said pellets; and
instructions for the repair of a composite ceramic pellet-containing panel and optionally

22. The kit of claim 21, further comprising tools for the removal of defective ceramic pellets within a composite ceramic pellet-containing armor; tools for applying said room-temperature curable binder or a combination thereof.

23. The kit of claim 21, further comprising a horizontal frame which can be assembled to comprise at least four sides and bounding a fillable void.

24. The kit of claim 21, wherein said room-temperature curable binder material comprises a polyurethane, an epoxy, an unsaturated polyester, an acrylic or a silicone.

25. A method for repairing a composite armor panel, said method comprising:
(a) replacing at least one of a plurality of ceramic bodies containing a curvature at an apical surface of said pellets within a composite armor panel whose removal is desired;
(b) applying a room-temperature curable binder material to an area proximal to that in which said at least one of said a plurality of substantially ceramic bodies was replaced such that said room temperature curable binder material substantially coats said at least one of a plurality of ceramic bodies, optionally leaving a portion of an outer surface area of said curvature of said ceramic bodies uncoated; and
(d) providing conditions whereby said room-temperature curable binder material cures and thereby forms an integral composite ceramic body-containing armor panel.

26. The method of claim 25, further comprising the step of placing a high-performance textile product underneath and proximal to the region wherein said at least one of a plurality of substantially ceramic bodies containing a curvature at an apical surface of said pellets within a composite armor panel whose removal is desired is located prior to said applying in step (b).

27. The method of claim 26, wherein said high-performance textile comprises Kevlar®, Dyneema® or Spectra®.

28. The method of claim 25, wherein said room-temperature curable binder material comprises a polyurethane, an epoxy, an unsaturated polyester, an acrylic or a silicone.

29. The method of claim 25, further comprising the step of applying a primer to said area proximal to that in which said at least one of said a plurality of substantially cylindrical ceramic pellets was replaced prior to applying said room-temperature curable binder material.

30. The method of claim 25, wherein said method makes use of the kit of claim 18 for said repair.
